(19) United States
(12) Patent Application Publication
(10) Pub. No.: US 2017/0130056 A1
(43) Pub. Date: May 11, 2017

(54) INORGANIC PARTICLES WITH IMPROVED FLOWABILITY

(71) Applicants: Dow Global Technologies LLC, Midland, MI (US); Rohm and Haas Company, Philanelphia, PA (US)

(72) Inventors: Tong Sun, Shanghai (CN); Yang Liu, Shanghai (CN); Yan Huang, Shanghai (CN); Tao Wang, Shanghai (CN)

(21) Appl. No.: 15/317,987

(22) PCT Filed: Jul. 4, 2014
(86) PCT No.: PCT/CN2014/081637

§ 371 Date: Dec. 12, 2016

(51) Int. Cl. C09C 3/04; C09C 3/10; C09D 7/12; C09D 133/12

(52) U.S. Cl. CPC C09C 3/043; C09D 133/12; C09C 3/10; C09D 7/1216

(57) ABSTRACT

The present invention provides spray-dried powders comprising from 0.1% to 25% a hydrophobic polymer, from 75% to 99.9% inorganic particles, and less than 3% a dispersant. The Tg of the hydrophobic polymer is less than 105° C., the average particle size of the inorganic particles is from 5 nm to 100 um, and the average particle size of the spray-dried powders is from 1 um to 400 um. The hydrophobic polymer comprises, as polymerization units, an ethylenically unsaturated nonionic monomer. The present invention further provides a process for the preparation of the spray-dried powders comprising (a) preparing a solution comprising the hydrophobic polymer, the inorganic particles, and the dispersant; and (b) adding the solution into a spray dryer and preparing the spray-dried powders.

### FIELD OF THE INVENTION

The present invention relates to inorganic particles with improved flowability. In particular, the present invention relates to composites of inorganic particles and polymer particles made by a spray-drying process.

### INTRODUCTION

Inorganic particles are widely used in industries, such as coating and three-dimensional printing industries. Inorganic particles have cohesive powers between each other and are easy to cohere together. Therefore, inorganic particles tend to have low flowability which is not good for most industrial applications. The particle cohesion is even significant in inorganic particles having a particle size of less than 30 um.

It is desired in the industries to provide treated inorganic particles with improved flowability.

### SUMMARY OF THE INVENTION

The present invention provides spray-dried powders comprising, by dry weight based on total dry weight of the powders, from 0.1% to 25% a hydrophobic polymer, from 75% to 99.9% inorganic particles, and less than 3% a dispersant. The glass transition temperature (Tg) of the hydrophobic polymer is less than 105° C., the average particle size of the inorganic particles is from 5 nm to 100 um, and the average particle size of the spray-dried powders is from lum to 400 um. The hydrophobic polymer comprises, as polymerization units, an ethylenically unsaturated nonionic monomer.

The present invention further provides a spray-drying process for the preparation of the spray-dried powders comprising (a) preparing a solution comprising the hydrophobic polymer, the inorganic particles, and the dispersant; and (b) adding the solution into a spray dryer and preparing the spray-dried powders.

### DETAILED DESCRIPTION OF THE INVENTION

The spray-dried powders of the present invention comprise, by dry weight based on total dry weight of the powders, from 0.1% to 25%, preferably from 0.5% to 20%, and more preferably from 1% to 18%, a hydrophobic polymer; and from 75% to 99.9%, preferably from 80% to 99.5%, and more preferably from 82% to 99%, inorganic particles.

The hydrophobic polymer has a Tg of less than 105° C., preferably less than 90° C., and more preferably less than 60° C.

The inorganic particles have an average particle size of from 5 nm to 100 um, preferably from 20 nm to 80 um, and more preferably from 200 nm to 40 um.

The spray-dried powders have an average particle size of from lum to 400 um, preferably from 2 um to 200 um, and more preferably from 3 um to 100 um.

As used herein, the term “average particle size” refers to the median particle size or diameter of a distribution of particles as determined for example, by a Multisizer™ 3 Coulter Counter™ (Beckman Coulter, Inc., Fullerton, Calif.) according to the procedure recommended by the manufacturer. The median particle size is defined as the size wherein 50wt % of the particles in the distribution are smaller than the median particle size and 50wt % of the particles in the distribution are larger than the median particle size. It is a volume average particle size.

Tg is calculated by the Fox equation (T.G. Fox, Bull. Am. Physics Soc., Volume 1, Issue No. 3, page 123 (1956)). That is, for calculating the Tg of a polymer of monomers Mi and M₂,

$$\frac{1}{{T}_{g} ( calc . )} = \frac{w ( {M}_{1} )}{{T}_{g} ( {M}_{1} )} + \frac{w ( {M}_{2} )}{{T}_{g} ( {M}_{2} )} ,$$

wherein Tg (calc.) is the glass transition temperature calculated for the polymer, w(M₁) is the weight fraction of monomer M₁ in the polymer, w(M₂) is the weight fraction of monomer M₂ in the polymer, Tg(M₁) is the glass transition temperature of the monomer of M₁, and Tg(M₂) is the glass transition temperature of the monomer of M₂. The glass transition temperatures of the monomers may be found, for example, in Polymer Handbook, edited by J. Brandrup and E. H. Immergut, Interscience Publishers.

Hydrophobic Polymer

The hydrophobic polymer of the present invention comprises, as polymerization units, an ethylenically unsaturated nonionic monomer. As used herein, the term “nonionic monomers” refers to monomers that do not bear an ionic charge between pH=1-14. Suitable examples of the ethylenically unsaturated nonionic monomers include alkyl esters of (methyl) acrylic acids such as methyl acrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxyethyl methacrylate, hydroxypropyl methacrylate, and any combination thereof; (meth)acrylonitrile; (meth)acrylamide; amino-functional and ureido-functional monomers such as hydroxyethyl ethylene urea methacrylate; monomers bearing acetoacetate-functional groups such as acetoacetoxyethyl methacrylate (AAEM); monomers bearing carbonyl-containing groups such as diacetone acrylamide (DAAM); ethylenically unsaturated monomers having a benzene ring such as styrene and substituted styrenes; butadiene; α-olefins such as ethylene, propylene, and 1-decene; vinyl acetate, vinyl butyrate, vinyl versatate and other vinyl esters; vinyl monomers such as vinyl chloride and vinylidene chloride; glycidyl (meth)acrylate; and any combination thereof.

The ethylenically unsaturated nonionic monomers are preferably selected from methyl methacrylate, ethyl acrylate, butyl acrylate, 2-ethylhexyl acrylate, styrene, vinyl acetate, vinyl butyrate, and any combination thereof.

The hydrophobic polymer of the present invention may further comprise from 0.1% to 5%, preferably from 0.2% to 3%, and more preferably from 0.5% to 2.5% by dry weight based on total dry weight of the hydrophobic polymer, a phosphorus-containing monomer. Suitable examples of the phosphorus-containing monomers include phosphoalkyl (meth)acrylates such as phosphoethyl (meth)acrylate, phosphopropyl (meth)acrylate, phosphobutyl (meth)acrylate, salts thereof, and any combination thereof; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho di-propylene glycol (meth)acrylate, phospho tri-propylene glycol (meth)acrylate, salts thereof, and any combination thereof. Suitable examples of the phosphorus-containing monomers further include SIPOMER™ COPS-3 and SIPOMER PAM-5000 both commercially available from Solvay Company. The phosphorous-containing monomers are preferably selected from mono- or di-ester of phosphoalkyl (meth)acrylates, more preferably are mono- or di-ester of phosphoethyl methacrylate, and most preferably are phosphoethyl methacrylate (PEM).

The hydrophobic polymer of the present invention may further comprise less than 10%, preferably less than 5% by dry weight based on total dry weight of the hydrophobic polymer, a stabilizer monomer. Suitable examples of the stabilizer monomers include sodium styrene sulfonate (SSS), sodium vinyl sulfonate (SVS), 2-acrylamido-2-methylpropanesulfonic acid (AMPS), acrylamide (AM), acrylic acid (AA), methylacrylic acid (MAA), itaconic acid (IA), and any combination thereof.

Hydrophilic Polymer

The spray-dried powders of the present invention may further comprise less than 10%, preferably less than 5%, and more preferably less than 3% by dry weight based on total dry weight of the spray-dried powders, a hydrophilic polymer. The hydrophilic polymers are soluble in water, and suitable examples of the hydrophilic polymers include alkylcellulose, hyrdoxcycellulose, hydroxyalkylcellulose, cellulose acetobutyrate (in water-dispersible form), cellulose nitrate, starch, alginates, chitosan, polyvinylalcohols, polyvinylpyrrolidones, polyacrylamides, polyacrylic acids, polyethyleneimines, pectins, and any combination thereof.

The Polymerization Method

The polymerization of the polymers can be any method known in the art, and includes emulsion polymerization and mini-emulsion polymerization.

The Inorganic Particles

The inorganic particles of the present invention are inorganic pigments or inorganic extenders. As used herein, the term “inorganic pigment” refers to a particulate inorganic material which is capable of materially contributing to the opacity (i.e., hiding capability) of a composition. Such materials typically have a refractive index of greater than 1.8, and include titanium dioxide (TiO₂), zinc oxide, zinc sulfide, barium sulfate, barium carbonate, and lithopone. TiO₂ is preferred. The term “inorganic extender” refers to a particulate inorganic material having a refractive index of less than or equal to 1.8 and greater than 1.3, and including calcium carbonate, clay, calcium sulfate, aluminosilicate, silicate, zeolite, mica, diatomaceous earth, aluminium oxide (Al₂O₃), zinc phosphate, solid or hollow glass, and ceramic bead. Calcium carbonate, clay, mica, and Al₂O₃ are preferred.

Additives

The spray-dried powders further comprise less than 3%, preferably less than 2% by dry weight based on total dry weight of the powders, a dispersant. Suitable examples of the dispersant include non-ionic, anionic and cationic dispersants such as polyacid with suitable molecular weight, 2-amino-2-methyl-1-propanol (AMP), dimethyl amino ethanol (DMAE), potassium tripolyphosphate (KTPP), trisodium polyphosphate (TSPP), citric acid and other carboxylic acids. Preferred dispersants are polyacids, i.e., homopolymers or copolymers of carboxylic acids, hydrophobically or hydrophilically modified polyacids, salts thereof, and any combination thereof. Suitable examples of the hydrophobically or hydrophilically modified polyacids include polyacrylic acid, polymethacrylic acid, and maleic anhydride modified with hydrophilic or hydrophobic monomers such as styrene, acrylate or methacrylate esters, diisobutylene. The molecular weight of such polyacid dispersant is from 400 to 50,000, preferably from 500 to 30,000, more preferably from 1000 to 10,000, and most preferably from 1,500 to 3,000.

The spray-dried powder may further comprise less than 3%, preferably less than 2% by dry weight based on total dry weight of the powders, a flow additive. Suitable examples of the flow additive include magnesium stearate, mannitol, stearyl alcohol, glyceryl monostearate, and any combination thereof.

The spray-dried powder may further comprise less than 3%, preferably less than 2% by dry weight based on total dry weight of the powders, a defoamer. The defoamer may be any suitable defoamer as known in the art. Suitable examples of the defoamer include siloxane based defoamers and minal oil based defoamers.

The spry-dried powder may further comprise less than 3%, preferably less than 2% by dry weight based on total dry weight of the powders, a thickener. Suitable examples of the thickener include polyvinyl alcohol (PVA), hydrophobically modified alkali soluble emulsions (HASE), alkali-soluble or alkali swellable emulsions (ASE), hydrophobically modified ethylene oxide-urethane polymers known in the art as HEUR, cellulosic thickeners such as hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose,2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose.

The spray-dried powders contain less than 2%, preferably less than 0.5%, and more preferably less than 0.1%, by weight based on total weight of the spray-dried powders, water.

The Spray-Drying Method

The spray-drying method involves the conversion of a solution droplet into dried powders by evaporation of the solvent/water in a one-step process through a spray dryer. It is well-known in the art that the desired particle morphologies and size distribution are achieved by controlled solids content of the solution, nozzle diameter, air inlet or air outlet temperature, pump speed, and air pressure of the spray dryer. In this invention, the hydrophobic polymer and the inorganic particles are mixed with by weight based on total weight of the solution, from 20% to 99% water, the dispersant, the defoamer, and the optional flow additive to form the solution. The solution is added into any commercially available spry dryer, such as Mini Spray Dryer B-290 from BUCHI Corporation, and GEA Niro Spray Dryer from GEA Process Engineering Inc. to prepare the desired spray-dried powders of the present invention.

### EXAMPLES

### I. RAW MATERIALS

| Chemicals | Supplier |
|---|---|
| OROTAN ™ 731A dispersant | The Dow Chemical Company |
| TEGO ™ 825 defoamer | Evonik Industries AG |
| EVOQUE ™ 1310 hydrophobic | The Dow Chemical Company |
| polymer | |
| TI-PURE ™ R-706 TiO₂ | E. I. du Pont de |
| | Nemours and Company |
| Aluminium oxide (Al₂O₃) | Zhengzhou Zhongtian Company |
| Zinc oxide (ZnO) | Sinopharm Chemical Reagent Company |
| Alumina trihydrate (Al(OH)₃) | Sinopharm Chemical Reagent Company |
| Magnesium stearate | Sinopharm Chemical Reagent Company |

### II. TEST METHODS

1. Flowability Test

The flowability of the spry-dried powders was determined by an ERWEKA Granulate Tester (from Erweka Company) equipped with a standard stainless steel funnel of 15 mm internal diameter and 30° inner angle to the vertical axis, and a balance. The spry-dried powders were introduced into the funnel, and were allowed for flowing from the funnel onto the balance in a pre-defined time period. The weight of the spry-dried powders flowed onto the balance in the pre-defined time period, i.e., two seconds in this test, was read and measured. For each spry-dried powders sample, three tests were conducted and the average flow rate (g/s; calculated by the weight of the spry-dried powders flowed onto the balance/the pre-defined time period) was recorded.

2. Average Particle Size

Median particle diameters (D50, um) were measured by a LS™ 13 320 Laser Diffraction Particle Size Analyzer available from Beckman Coulter, Inc. to illustrate the average particle size, i.e., particle size distribution of the spray-dried powders.

### III. EXAMPLES

Preparation of Spray-dried Powders 2 through 6, 9, 12, 15 through 17, and 19, and Comparative Powders 7, 10, 13 and 18

A 20% solids solution was made by mixing TI-PURE R-706 TiO2, EVOQUE 1310 hydrophobic polymer (45% solids) with water, and 6g of the OROTAN 731A dispersant, and 1.3 g of the TEGO 825 defoamer in a high-speed mixer at a shear speed of 1500 rpm. The amounts of TI-PURE R-706 TiO₂ and EVOQUE 1310 hydrophobic polymer were different in different examples and were listed in Table 1. The solution was added into a Mini Spray Dryer B-290 available from BUCHI Corporation and the device was set so that the nozzle diameter equals to 1mm, the temperature of air inlet equals to 120° C., the temperature of air outlet equals to 100° C., the pump speed equals to 0.45 L per hour, and the air pressure equals to about 196 kPa.

The Spray-dried Powders were collected from the product collection vessel of the spray dryer.

Comparative Powders 1, 8, 11 and 14 were respectively 100% commercially available inorganic particles of TI-PURE R-706 TiO₂, Al(OH)₃, ZnO and Al₂O₃, as shown in Table 1. Comparative Powders 1, 8, 11 and 14 were neither treated with polymer nor spray-dried.

The Spray-dried Powder 19 used the same formation of the Spray-dried Powder 2, except that Spray-dried Powder 19 further comprised 2.5% by weight based on total weight of the solution, of a magnesium stearate.

TABLE 1

| | TI-PURE R-706 | EVOQUE 1310 |
|---|---|---|
| Examples (100 wt %) | TiO₂ or others^{#} | hydrophobic polymer\hat{ } |
| Comparative Powders 1* | 100% | — |
| Spray-dried Powders 2 | 99.01% | 0.99% |
| Spray-dried Powders 3 | 97.09% | 2.91% |
| Spray-dried Powders 4 | 95.24% | 4.76% |
| Spray-dried Powders 5 | 93.02% | 6.98% |
| Spray-dried Powders 6 | 90.91% | 9.09% |
| Comparative Powders 7* | 71.43% | 28.57% |
| Comparative Powders 8* | 100% Al(OH)₃ | — |
| Spray-dried Powders 9 | 90.91% Al(OH)₃ | 9.09% |
| Comparative Powders 10* | 71.43% Al(OH)₃ | 28.57% |
| Comparative Powders 11* | 100% ZnO | — |
| Spray-dried Powders 12 | 90.91% ZnO | 9.09% |
| Comparative Powders 13* | 71.43% ZnO | 28.57% |
| Comparative Powders 14* | 100% Al₂O₃ | — |
| Spray-dried Powders 15 | 95.24% Al₂O₃ | 4.76% |
| Spray-dried Powders 16 | 90.91% Al₂O₃ | 9.09% |
| Spray-dried Powders 17 | 83.33% Al₂O₃ | 16.67% |
| Comparative Powders 18* | 71.43% Al₂O₃ | 28.57% |

^{#}Unless otherwise defined, the inorganic particles used in the examples are TI-PURE R-706 TiO₂.
*Comparative Powders 1, 8, 11 and 14 were neither treated with polymer nor spray-dried. Comparative Powders 7, 10, 13 and 18 were treated with polymer and spray-dried.
\hat{ }EVOQUE 1310 hydrophobic polymer is a hydrophobic polymer comprising BA, MMA and PEM.

IV. Results

The median particle sizes of commercially available inorganic particles are listed below: TiO₂ is about 0.270 um to 0.330 um; Al(OH)₃ is about 0.4 to 100 um; ZnO is about 0.05 to 100 um; and Al₂O₃ is about 0.5 to 100 um. The median particle sizes of spray-dried powders were shown in Table 2.

TABLE 2

| wt % | Median particle size | | Flowability (g/s) |
|---|---|---|---|
| Comparative Powders 1* | 0.300 | um | 0.00 |
| Spray-dried Powders 2 | 3.389 | um | 1.73 |
| Spray-dried Powders 3 | 3.834 | um | 5.13 |
| Spray-dried Powders 4 | 5.297 | um | 7.97 |
| Spray-dried Powders 5 | 4.504 | um | 11.1 |
| Spray-dried Powders 6 | 4.802 | um | 7.43 |
| Comparative Powders 7* | 6.756 | um | 0.00 |
| Comparative Powders 8* | 3.358 | um | 0.53 |
| Spray-dried Powders 9 | 18.37 | um | 7.93 |
| Comparative Powders 10* | 24.83 | um | 0.00 |
| Comparative Powders 11* | 30.08 | um | 13.17 |
| Spray-dried Powders 12 | 15.91 | um | 40.57 |
| Comparative Powders 13* | 19.35 | um | 0.00 |
| Comparative Powders 14* | 39.37 | um | 2.03 |
| Spray-dried Powders 15 | 5.873 | um | 5.30 |
| Spray-dried Powders 16 | 6.877 | um | 7.93 |
| Spray-dried Powders 17 | 13.19 | um | 9.27 |
| Comparative Powders 18* | 21.61 | um | 0.00 |
| Spray-dried Powders 19 | 3.435 | um | 1.89 |

*Comparative Powders 1, 8, 11 and 14 were neither treated with polymer nor spray-dried. Comparative Powders 7, 10, 13 and 18 were treated with polymer and spray-dried.

Spray-dried Powders 2 to 6 compared to Comparative Powders 1, Spray-dried Powders 9 compared to Comparative Powders 8, Spray-dried Powders 12 compared to Comparative Powders 11, and Spray-dried Powders 15 to 17 compared to Comparative Powders 14; showed improved flow-abilities (higher flow rate). This indicated that by treating the inorganic particles with hydrophobic polymer and spray-drying method, the flowability of the spray-dried powder was significantly increased. Comparative Powders 7, 10, 13 or 18 were inorganic powders treated by hydrophobic polymer and spray-dried method. The concentration of the hydrophobic polymer in Comparative Powders 7, 10, 13 or 18 was higher than the recommended amount, i.e., the upper limit of the present invention. The flowability of Comparative Powders 7, 10, 13 or 18 was not acceptable and was significantly lower compared respectively to the flowability of Spray-dried Powders 2 to 6, Spray-dried Powders 9, Spray-dried Powders 12, or Spray-dried Powders 15 to 17 comprising the hydrophobic polymer at a recommended concentration. This indicated that the concentration of the hydrophobic polymer was also critical and limited. Spray-dried Powders 19 further comprised 0.5% by weight based on total weight of the solution, of a magnesium stearate, compared to Spray-dried Powders 2 and had a further improved flowability (from 1.73 to 1.89).

What is claimed is:

1. Spray-dried powders comprising, by dry weight based on total dry weight of the powders, from 0.1% to 25% a hydrophobic polymer, from 75% to 99.9% inorganic particles, and less than 3% a dispersant; wherein the Tg of the hydrophobic polymer is less than 105° C., the average particle size of the inorganic particles is from 5 nm to 100 um, and the average particle size of the spray-dried powders is from lum to 400 um; wherein the hydrophobic polymer comprises, as polymerization units, an ethylenically unsaturated nonionic monomer.

2. The spray-dried powders according to claim 1 further comprising less than 2% by weight based on total weight of the spray-dried powders, water.

3. The spray-dried powders according to claim 1 further comprising less than 5% by dry weight based on total dry weight of the spray-dried powders, a hydrophilic polymer.

4. The spray-dried powders according to claim 1 further comprising less than 3% by dry weight based on total dry weight of the powders, a flow additive.

5. The spray-dried powders according to claim 1 wherein the hydrophobic polymer further comprises less than 10% by dry weight based on total dry weight of the hydrophobic polymer, a stabilizer monomer.

6. The spray-dried powders according to claim 1 wherein the hydrophobic polymer further comprises from 0.1% to 5% by dry weight based on total dry weight of the hydrophobic polymer, a phosphorus-containing monomer.

7. The spray-dried powders according to claim 1 wherein the phosphorous-containing monomers are selected from mono- or di-ester of phosphoalkyl (meth)acrylates.

8. The spray-dried powders according to claim 7 wherein the phosphorus-containing monomer is phosphoethyl methacrylate.

9. The spray-dried powders according to claim 1 wherein the ethylenically unsaturated nonionic monomer is selected from methyl methacrylate, ethyl acrylate, butyl acrylate, 2-ethylhexyl acrylate, styrene, vinyl acetate, vinyl butyrate, and any combination thereof.

10. The spray-dried powders according to claim 1 wherein the hydrophobic polymer is from 1% to 18% by dry weight based on total dry weight of the spray-dried powders.

11. The spray-dried powders according to claim 1 wherein the inorganic particles are from 82% to 99% by dry weight based on total dry weight of the spray-dried powders.

12. The spray-dried powders according to claim 1 wherein the Tg of the hydrophobic polymer is less than 60° C.

13. The spray-dried powders according to claim 1 wherein the average particle size of the inorganic particles is from 200 nm to 40 um.

14. The spray-dried powders according to claim 1 wherein the average particle size of the spray-dried powders is from 3 um to 100 um.

15. A spray-drying process for preparation of the spray-dried powders according to claim 1 comprising the steps of:
(a) preparing a solution for spray-drying comprising by dry weight based on total dry weight of the solution, from 0.1% to 25% a hydrophobic polymer, from 75% to 99.9% inorganic particles, and less than 3% a dispersant;
(b) adding the solution into a spray dryer and preparing the spray-dried powders;
wherein the Tg of the hydrophobic polymer is less than 105° C., the average particle size of the inorganic particles is from 5 nm to 100 um, and the average particle size of the spray-dried powders is from lum to 400 um; wherein the hydrophobic polymer comprises, as polymerization units, an ethylenically unsaturated nonionic monomer.
